(19) United States
(12) Patent Application Publication
(10) Pub. No.: US 2015/0343581 A1
(43) Pub. Date: Dec. 3, 2015

(54) TOOL CHANGE DEVICE OF CNC MACHINE CENTER

(71) Applicant: Feng-Tien Chen, Taichung City (TW)

(72) Inventor: Feng-Tien Chen, Taichung City (TW)

(21) Appl. No.: 14/289,662

(22) Filed: May 29, 2014

(51) Int. Cl. B23Q 3/157

(52) U.S. Cl. CPC B23Q 3/15713

(57) ABSTRACT

A tool change device is applicable to a CNC machine center that includes a machining spindle and includes first and second tool change units. The first and second tool change units each include a tool magazine and a tool change arm having a gripper. As such, the tool change device of the CNC machine center is allowed to manage twice tools and the grippers are respectively mounted to different tool change arms for being simultaneously put into operation in an individually-moving and not interfering manner. When one of the grippers is operable to grip a tool-to-be-changed from the spindle, the other gripper is allowed to hold a new tool and located at a position close to the spindle for being ready for immediately change of tools. As such, the time required for a cycle of tool change is greatly reduced.

### (a) TECHNICAL FIELD OF THE INVENTION

The present invention generally relates to a tool change device of a CNC (Computer Numerical Control) machine center, and more particularly to a tool change device of a CNC machine center that helps shorten the tool change time.

### (b) DESCRIPTION OF THE PRIOR ART

Referring to FIG. 1, a conventional CNC machine center 1 comprises a chassis 11, a machining unit 12 that is slidably mounted to the chassis 11 and is reciprocally movable in a vertical direction, a too change unit 13 that is mounted on the chassis 11 and located at one side of the machining unit 12, and a work table 14 that is movably mounted on the chassis 11 for receiving and retaining a work piece (not shown) thereon. The machining unit 12 comprises a spindle 121 to which a tool 10 is attachable and which is rotatable about a center axis thereof. The CNC machine center 1 has a computer system that controls, in response to instructions from a user, the operations of each of the machining unit 12, the spindle 121, and the work table 14. As such, the tool 10 can be driven by the spindle 121 to rotate and to machine the work piece positioned on the work table 14.

When the work piece needs to be machined with another type of tool 10, the tool change unit 13 is operated to change the tool for the spindle 121. The tool change unit 13 comprises a tool magazine 131 that comprises a plurality of tools 10 arranged therein and a tool change arm 133 that is arranged between the tool magazine 131 and the spindle 121. The tool change arm 133 is movable in the vertical direction and is also rotatable and comprises two tool grippers 134 that are respectively set at two opposite ends thereof. The computer system of the CNC machine center 1 is operable to respond to an instruction from the user to move a selected tool 10 to a tool exit port 132 of the tool magazine 133. The tool grippers 134 are operable to respectively clamp and hold the tools 10 that are respective located on the spindle 121 and at the tool exit port 132 and then revolves 180 degrees to exchange the positions of the tool-to-be-changed 101 that is located on the spindle 121 and a new tool 102 that is supplied from the tool magazine 131. As such, the process of tool change is completed. Details of the tool change process will be described as follows:

Referring to FIGS. 2 and 3, to carry out tool change, the tool change arm 133 is controlled by the computer system and sets out from a home position between the tool exit port 132 of the tool magazine 131 and the spindle 121 and rotates 90 degrees to reach the position shown in FIGS. 4 and 5. Under this condition, the grippers 134 respectively oppose a center of the spindle 121 and the tool exit port 132 to grip a tool-to-be-changed 101 that is attached to the spindle 121 and a new tool 102 located at the tool exit port 132.

Referring to FIGS. 6 and 7, the tool change arm 133 slides downward to pull the tools 101, 102 gripped by the grippers 134 out of the spindle 121 and the tool exit port 132.

Referring to FIGS. 8 and 9, the tool change arm 133 rotates by 180 degrees to switch the tool-to-be-changed 101 removed from the spindle 121 to the position corresponding to the tool exit port 132 and the new tool 102 picked up from the tool magazine 131 to a position corresponding to the center of the spindle 121.

Referring to FIGS. 10 and 11, the tool change arm 133 slides upward again to have the new tool 102 attached to the spindle 121 and the tool-to-be-changed 101 placed in the tool exit port 132 to be stored back in the tool magazine 131. Afterwards, the tool change arm 133 rotates 90 degrees to return to the home position shown in FIGS. 2 and 3 to complete a tool change process with which the total rotation angle equals 360 degrees.

Referring to FIGS. 1, 7, and 9, it can be easily found from the above described process of tool change that since the grippers 134 are respectively set at two ends of the same tool change arm 133, after one of the grippers 134 removes the tool-to-be-changed 101 from the spindle 121, the other one of the grippers 134 must make a rotation of 180 degrees to attach a new tool 102 to the spindle 121. This takes about a half of the time period of a tool change cycle and also makes it impossible for the gripper 134 that carries a new tool 102 to get standby at a location close to the center of the spindle 121 in order to install the new tool 102 immediately after the tool-to-be-changed 101 is removed. Thus, increasing the efficiency of the tool change process is generally limited.

It can be appreciated that if the grippers 134 are arranged at different tool change arms 133, so that when one of the grippers 134 is at a position corresponding to the spindle 121, the other one of the grippers 134 get, in advance, a new tool 102 and get ready for tool changing at a location close to the spindle 121. After the gripper 134 that removes the tool-to-be-changed 101 from the spindle 121 is leaving away from the position corresponding to the center of the spindle 12, the other gripper 134 may take the position and immediately install the new tool 102, thereby greatly saving the time period necessary for a tool change cycle.

Referring to FIG. 12, Taiwan Utility Model Application No. 102207866 discloses a CNC machining center 2, which, beside a first tool change unit 21 that is traditionally used, comprises an additional second tool change unit 22 that is identical to the first tool change unit 21. The tool change units 21, 22 each comprise a tool magazine 211, 221 and a tool change arm 212, 222 that has two ends each comprising a gripper 213, 223. However, although an advantage that the number and type of the tools 20 that can be received in the tool magazines 211, 221 are both doubled due to the number of the tool magazines being double can be achieved, yet the second tool change unit 22 is simply provided as a backup means for the purposes of taking the place of the first tool change unit 21 when the later is malfunctioning without shutting down the entire device for maintenance. Further, the tool change arms 212, 222 that each comprise two grippers 213, 223 may interfere with each other, or may collide the spindle 23 of the CNC machine center 2, if they are put into operations at the same time, so that it is general impossible to achieve an operation that a tool 20 is ready to immediately change through cooperative operations of the two tool change arms 212, 222.

### SUMMARY OF THE INVENTION

Thus, an object of the present invention is to provide a tool change device of a CNC machine center that helps save the time for changing tools.

The present invention provides a tool change device that is applicable to being mounted to a CNC machine center. The CNC machine center comprises a chassis unit and a machining unit that is mounted to the chassis unit and is reciprocally movable along a center axis. The machining unit comprises a spindle that is mounted along the center axis to receive a tool to be removably attached thereto. The tool change device of the CNC machine center comprises a first tool change unit, and a second tool change unit.

The first tool change unit is arranged at a side of the center axis and comprises a first tool magazine that receives and holds therein a plurality of tools and has a tool exit port and a first tool change arm arranged between the spindle and the first tool magazine. The first tool change arm comprises a first fixed end and a first tool gripper that is distant from the first fixed end and selectively and releasable grips a tool.

The second tool change unit is arranged at an opposite side of the center axis and comprises a second tool magazine that receives and holds a plurality of tools and has a tool exit port and a second tool change arm arranged between the spindle and the second tool magazine. The second tool change arm comprises a second fixed end and a second tool gripper that is distant from the second fixed end and selectively and releasably grips a tool.

The first and second tool grippers are operable to rotate about the first and second fixed ends so as to each circulate between the spindle and the respective tool exit port to have a tool attached to the spindle and one of the tools of the first and second tool magazines exchange with each other in such a way that the first and second tool grippers do not contact each other during the rotation thereof.

The efficacy of the present invention is that the tool change device of the CNC machine center comprises two grippers that are respectively arranged on different tool change arms so that the tool change arms are operable simultaneously to cooperate with each other for shortening the time required for a tool change process thereby achieving an advantage of greatly improving the performance of manufacturing.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view showing components of a conventional CNC machine center.

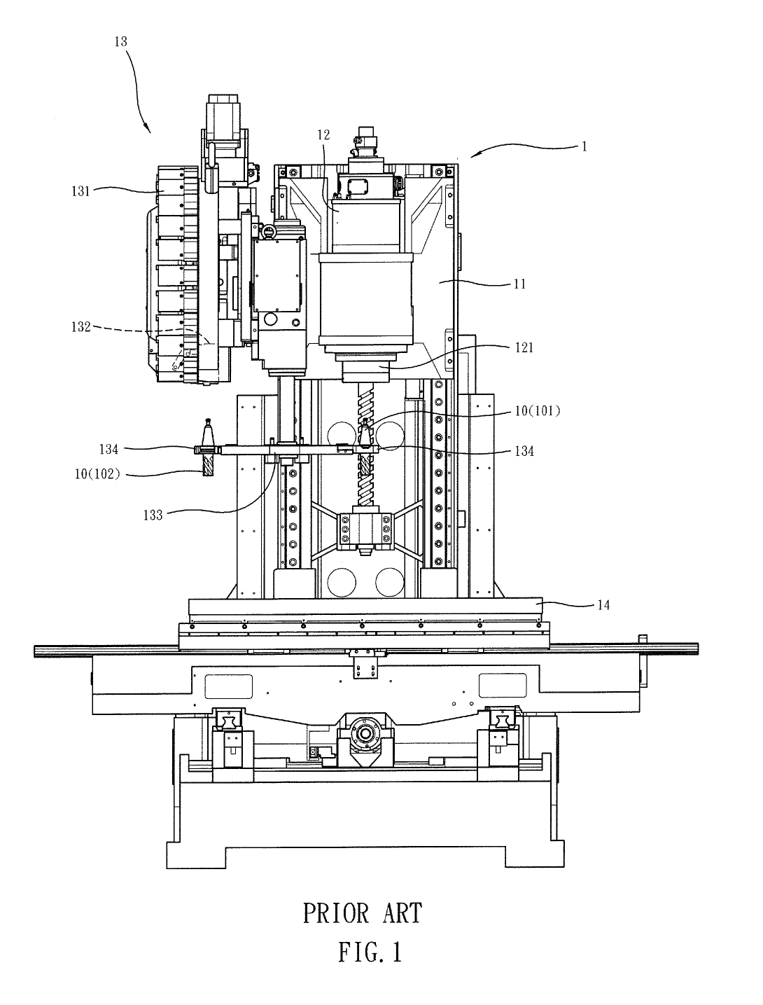

FIG. 2 is a front view illustrating a tool change arm of the CNC machine center located at a home position and between a tool magazine and a spindle of the CNC machine center.

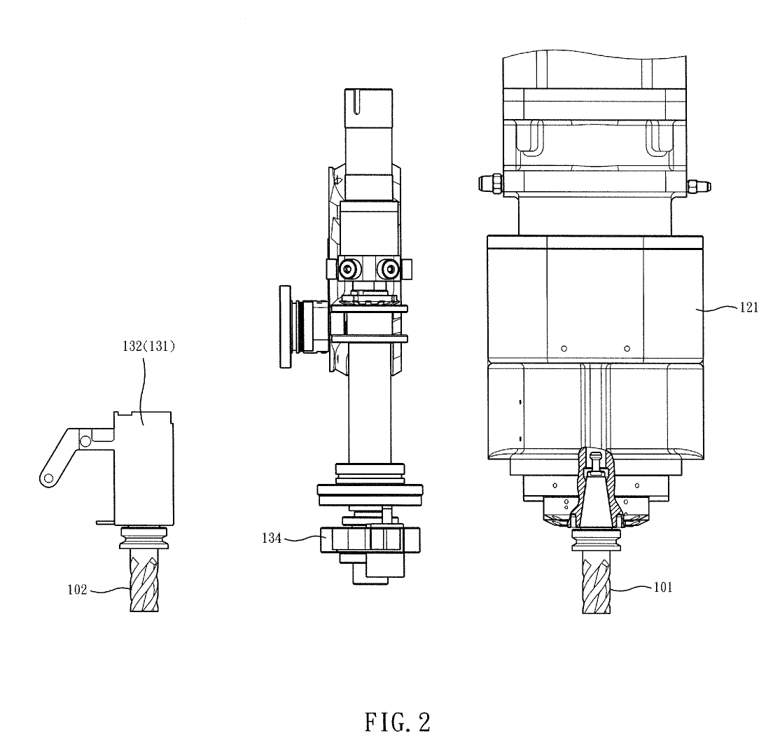

FIG. 3 is a top view of FIG. 2.

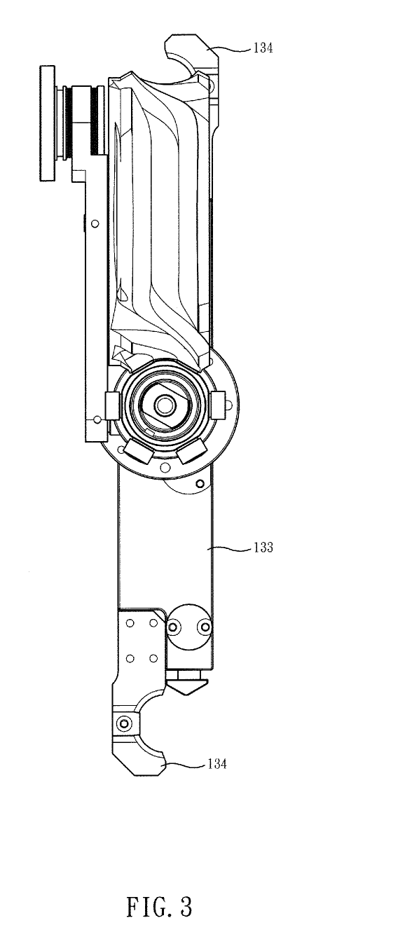

FIG. 4 is a front view illustrating the tool change arm rotating by 90 degrees and two grippers of the tool change arm respectively corresponding to a tool exit port of a tool magazine and a spindle center and each gripping a tool.

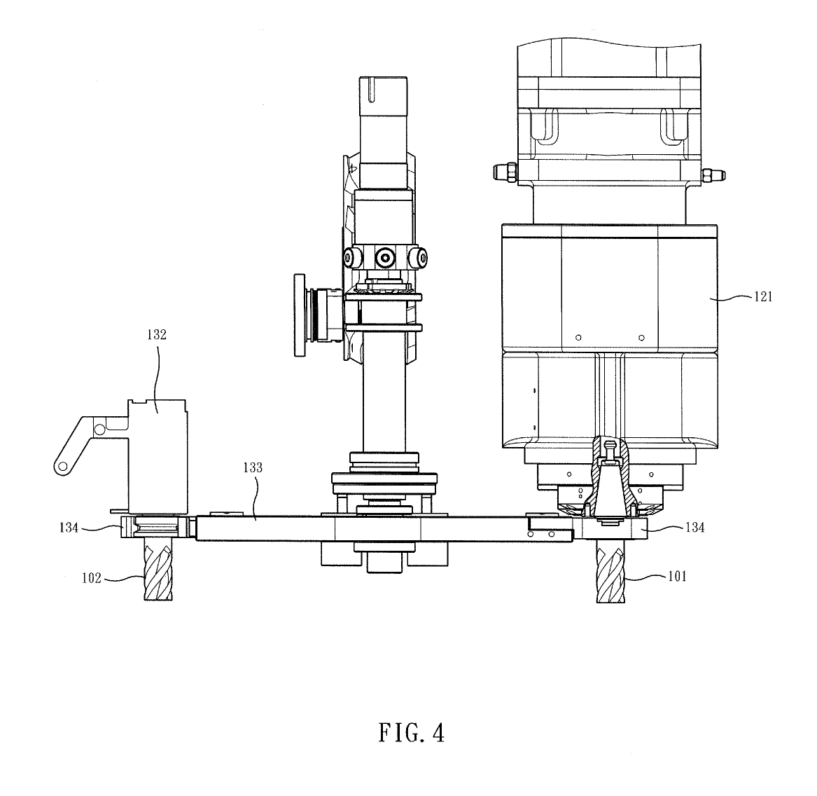

FIG. 5 is a top view of FIG. 4.

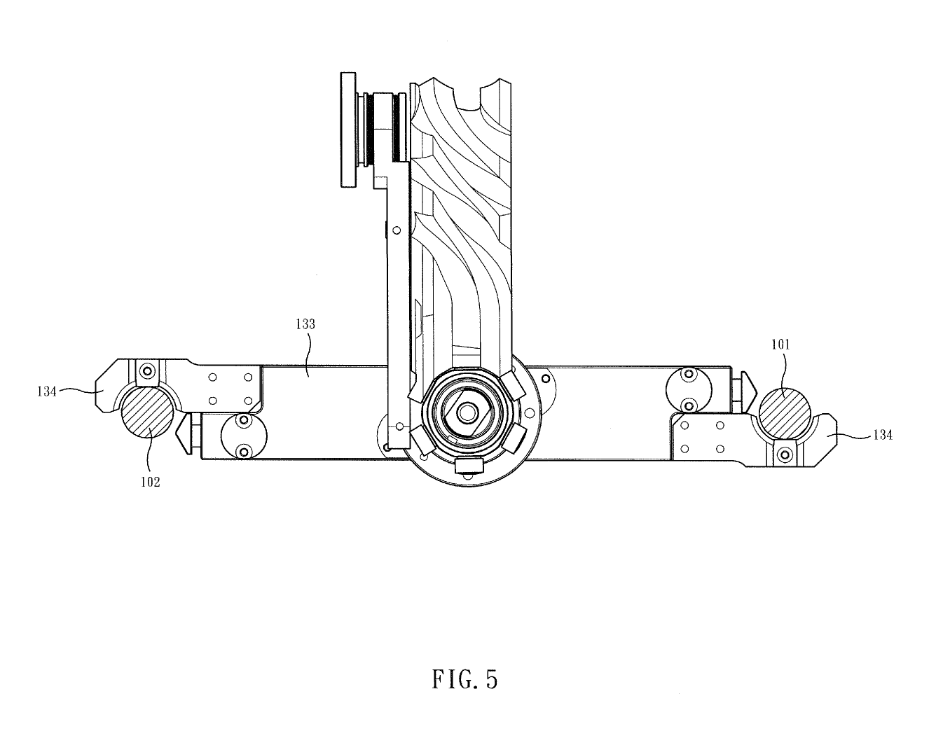

FIG. 6 is a front view illustrating the tool change arm sliding downward to pull the tools out of the tool exit port and the spindle.

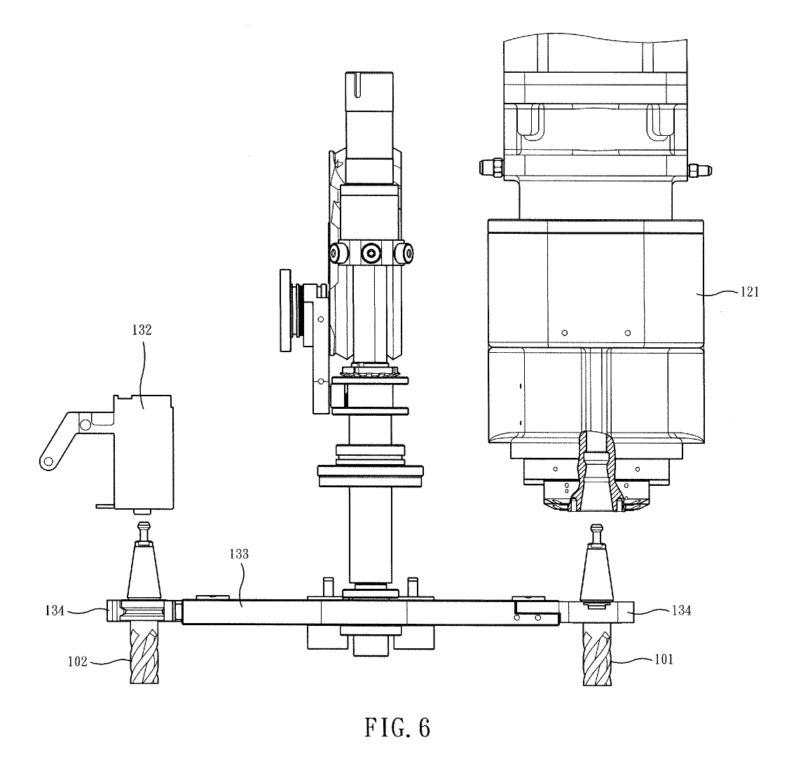

FIG. 7 is a top view of FIG. 6.

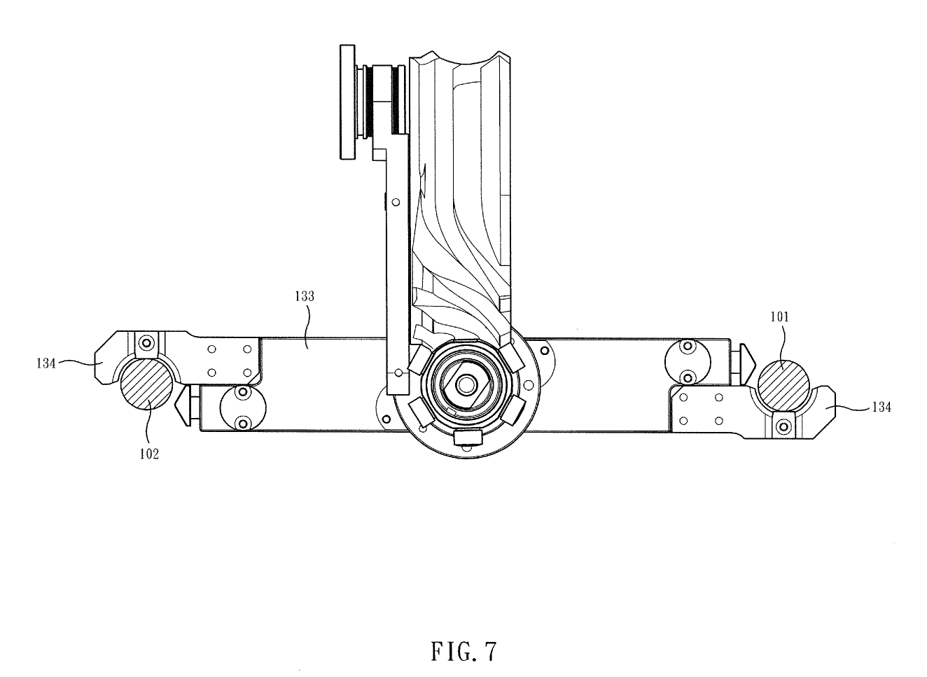

FIG. 8 is a front view illustrating the tool change arm rotating by 180 degrees so that the grippers exchange the tools of the tool exit port and the spindle.

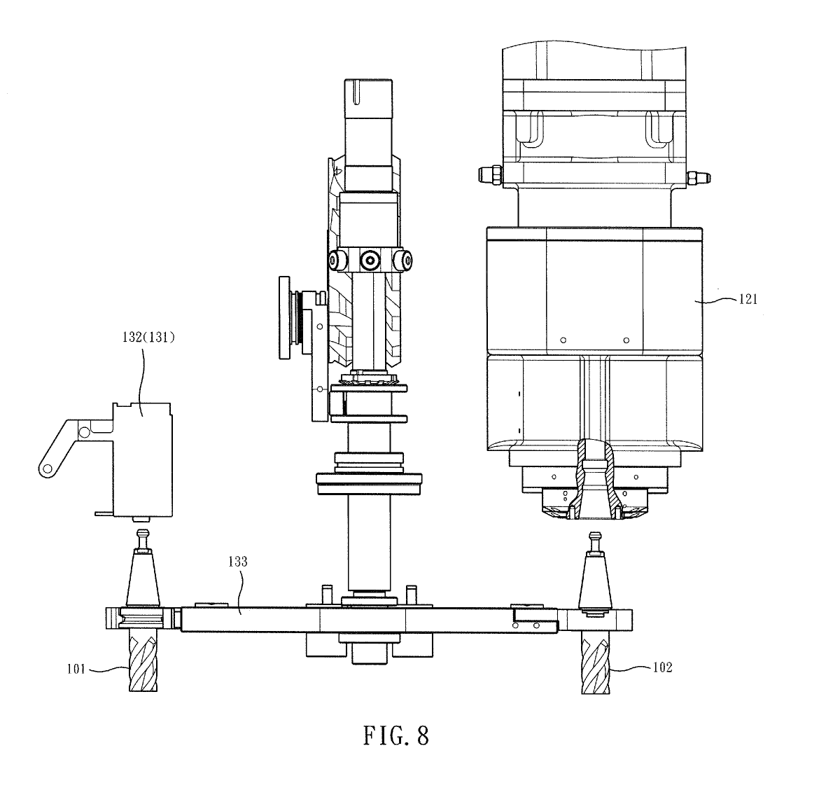

FIG. 9 is a top view of FIG. 8.

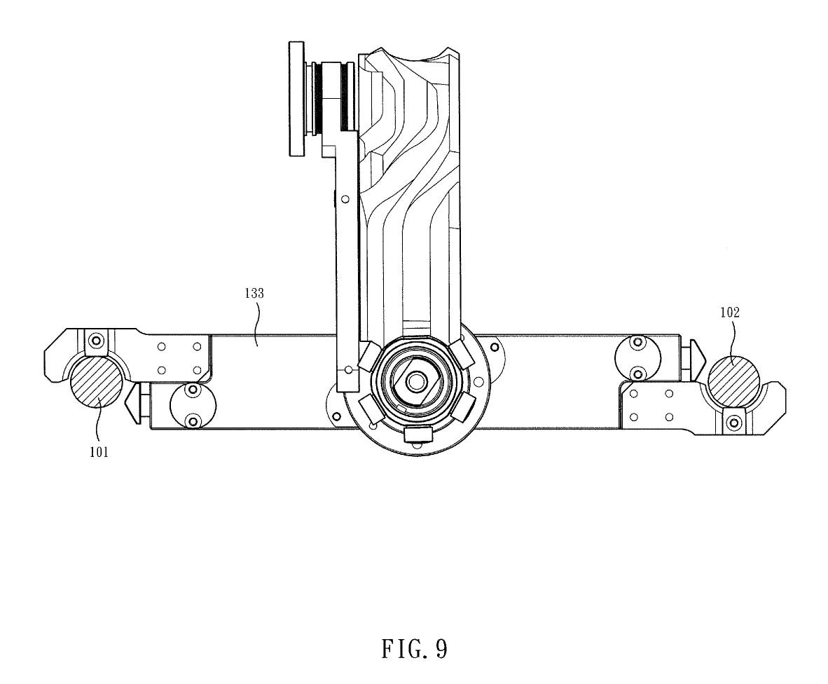

FIG. 10 is a front view illustrating the tool change unit sliding upward to have the tools respectively set to the tool magazine and the spindle.

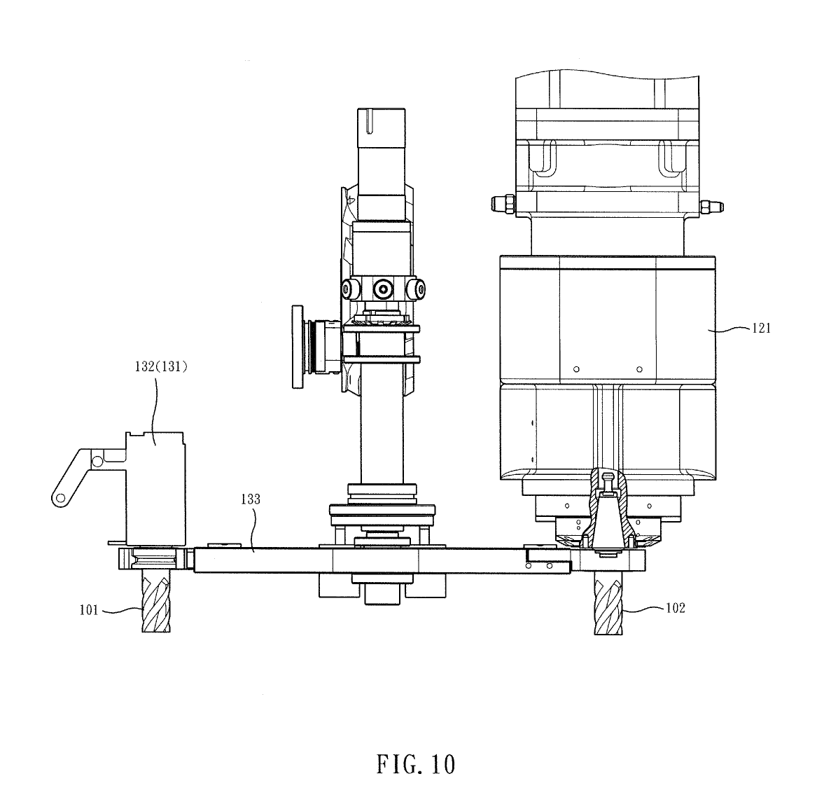

FIG. 11 is a top view of FIG. 10.

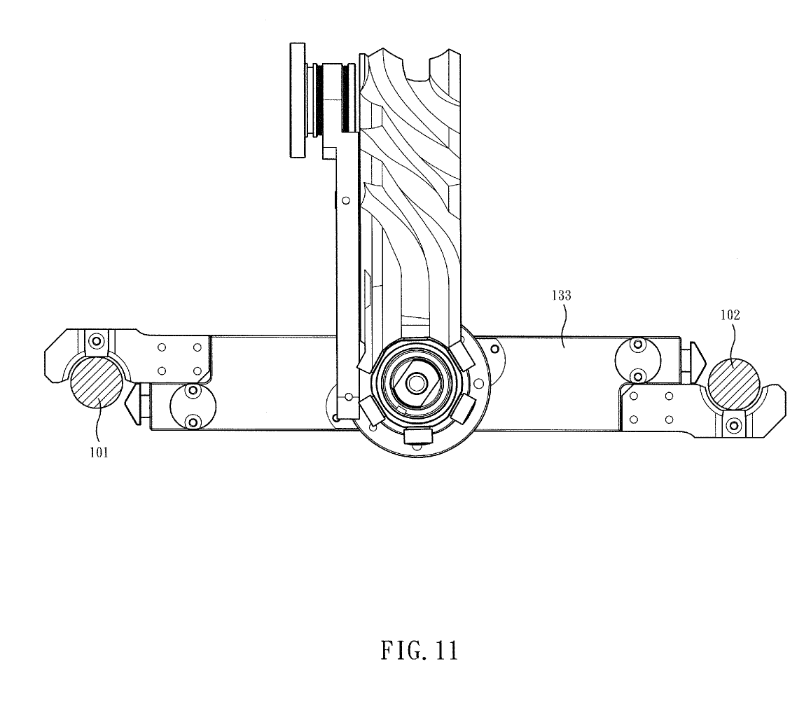

FIG. 12 is a front view showing components of a conventional CNC machining center.

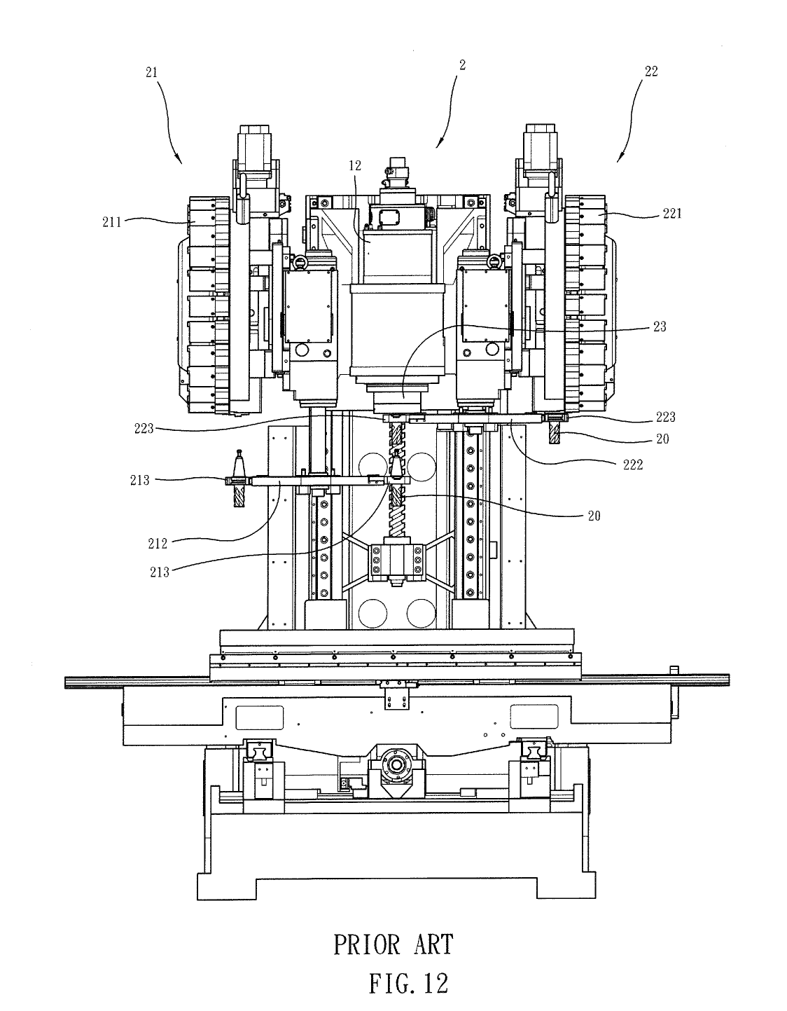

FIG. 13 is a front view showing a tool change device according to a preferred embodiment of the present invention mounted to a CNC machine center.

FIG. 14 is a front view illustrating a first tool gripper and a second tool gripper of the preferred embodiment of the tool change device, wherein the first and second tool grippers are respectively at a home position and a magazine position.

FIG. 15 is a top view of FIG. 14.

FIG. 16 is a front view illustrating the first tool gripper rotating 90 degrees to reach a spindle position to grip a tool-to-be-changed and the second tool gripper picking up a new tool from a second tool magazine of the preferred embodiment.

FIG. 17 is a top view of FIG. 16.

FIG. 18 is a front view illustrating the first tool gripper removing the tool-to-be-changed and the second tool gripper rotating to a location close to the spindle position for being ready for tool change.

FIG. 19 is a top view of FIG. 18.

FIG. 20 is a front view illustrating the first tool gripper leaving the spindle position and rotating to the magazine position and the second tool gripper taking the spindle position to install the new tool.

FIG. 21 is a top view of FIG. 20.

FIG. 22 is a front view illustrating the first tool gripper placing the tool-to-be-changed back into a first tool magazine of the preferred embodiment and the second tool gripper rotating 90 degrees back to [symbol] the home position.

FIG. 23 is a top view of FIG. 2.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

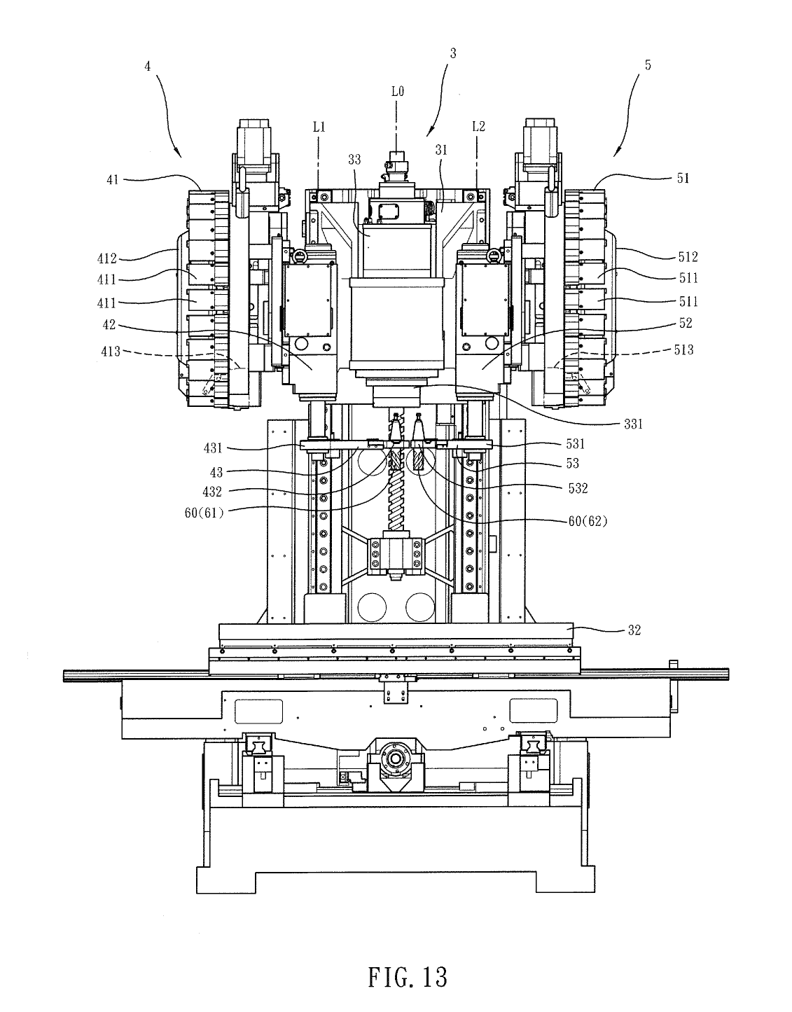

Referring to FIG. 13, the present invention provides a tool change device for a CNC (Computer Numerical Control) machine center of which a preferred embodiment described herein is applicable to a CNC machine center 3 and comprises a first tool change unit 4 and a second tool change unit 5. The CNC machine center 3 comprises a chassis unit 31, a work table 32 that is movably mounted on the chassis unit 31 to receive a work piece (not shown) to be positioned and retained thereon, and a machining unit 33 that is mounted to the chassis unit 31 and is reciprocally movable along a center axis L0. The machining unit 33 comprises a spindle 331 that is mounted along the center axis L0 to receive a tool 60 to be removably attached thereto. The spindle 331 is rotatable about the center axis L0 to drive the tool 60 attached thereto to rotate. The work table 32, the machining unit 33, and the spindle 331 are controlled by a computer system of the CNC machine center 3 to carry out operations according to instructions from a user in order to proceed with operations of milling, drilling, or grinding on the work piece retained on the work table 32.

The instant embodiment is described with reference to a vertical CNC machine center 3 that is taken as an example for illustration. Thus, the machining unit 33 is set to reciprocally move in a vertical direction. However, the present invention is not limited to such an example and in a practical application, the present invention is equally applicable to a horizontal CNC machine center (not shown).

When the work piece needs to be machined with other types of tools 6, the first and second tool change units 4, 5 are operable to change tools for the spindle 331. The first tool change unit 4 is mounted on the chassis unit 31 and is arranged at one side of the center axis L0. The second tool change unit 5 is mounted on the chassis unit 31 and is arranged at an opposite side of the center axis L0. Since the CNC machine center 3 is of a vertical configuration in the instant embodiment, the first and second tool change units 4, 5 are respectively set at the left hand side and the right hand side of the chassis unit 31 of the CNC machine center 3.

The first tool change unit 4 comprises a first tool magazine 41 that receives and holds therein a plurality of tools 60, a first toothed cam drive mechanism 42 arranged between the spindle 331 and the first tool magazine 41, and a first tool change arm 43 that is movably mounted to the first toothed cam drive mechanism 42. The first tool magazine 41 comprises a plurality of tool holders 411 that is arranged in an annular configuration and a tool striking mechanism 412. The first tool change arm 43 comprises a first fixed end 431 and a first tool gripper 432 that is distant from the first fixed end 431 and selectively and releasable grips a tool 60.

The tool holders 411 are provided for receiving and holding a set of tools 60 and are driven by the first toothed cam drive mechanism 42 to rotate. The computer system of the CNC machine center 3 is operable to have a selected one of the tools 60 and the tool holder 411 thereof to rotate to a lowermost position, where the tool 60 is forced out of the tool holder 411 by the tool striking mechanism 412. As such, the tool 60 can be driven to extend out of the first tool magazine 41 via a tool exit port 413 to be gripped by the first tool change arm 43.

The second tool change unit 5 comprises a second tool magazine 51 that receives and holds therein a plurality of tools 60, a second toothed cam drive mechanism 52 arranged between the spindle 331 and the second tool magazine 51, and a second tool change arm 53 that is movably mounted to the second toothed cam drive mechanism 52. The second tool magazine 51 comprises a plurality of tool holders 511 that is arranged in an annular configuration and a tool striking mechanism 512. The second tool change arm 53 comprises a second fixed end 531 and a second tool gripper 532 that is distant from the second fixed end 531 and selectively and releasable grips a tool 60.

The second tool change unit 5 comprises components and the functions associated therewith that are substantially identical to those of the first tool change unit 4 so that repeated description will be omitted herein. The tool striking mechanism 512 of the second tool change unit 5 is similarly operable to force a selected one of the tools 60 out of a tool exit port 513 to be gripped by the second tool change arm 53.

The first and second tool grippers 432, 532 are respectively controlled by the computer system of the CNC machine center 3 and driven by the first and second toothed cam drive mechanisms 42, 52 to proceed with vertical movement and rotation with respect to the chassis unit 31. To make movement, the first tool gripper 432 moves, reciprocally, along a first axis L1 that extends through the first fixed end 431 and is parallel to the center axis L0 and the second tool gripper 532 moves, reciprocally, along a second axis L2 that extends through the second fixed end 531 and is parallel to the center axis L0. To make rotation, the first and second tool grippers 432, 532 respectively rotate about the first and second axes L1, L2 to circulatively rotate between the spindle 331 and the respective tool exit port 413, 513.

As such, the first and second tool grippers 432, 532 each are circulatively rotatable among a home position, a spindle position, and a magazine position of its own. The spindle positions of the first and second tool grippers 432, 532 overlap each other. When located at the spindle position, the first and second tool grippers 432, 532 each oppose the spindle 331, where the first and second tool grippers 432, 532 are each movable downward and remove a tool-to-be-changed 61 from the spindle 331 or movable upward to attach a tool 62 to the spindle 331. When located at the magazine positions, the first and second tool grippers 432, 532 respectively oppose the tool exit ports 413, 513 and are movable upward to place the tools-to-be-changed 61 removed from the spindle 331 into the tool exit ports 413, 513 or movable downward to pick up news tool 62 from the tool exit ports 413, 513.

As such, the first and second tool grippers 432, 532 are operable to exchange the tools-to-be-changed 61 that are attached to the spindle 331 and the new tools 62 that extend out of the first and second tool magazines 41, 51 with each other and the first and second tool grippers 432, 532, when in rotation, do not contact each other. The tool change operations of the first and second tool grippers 432, 532 will be described as follows:

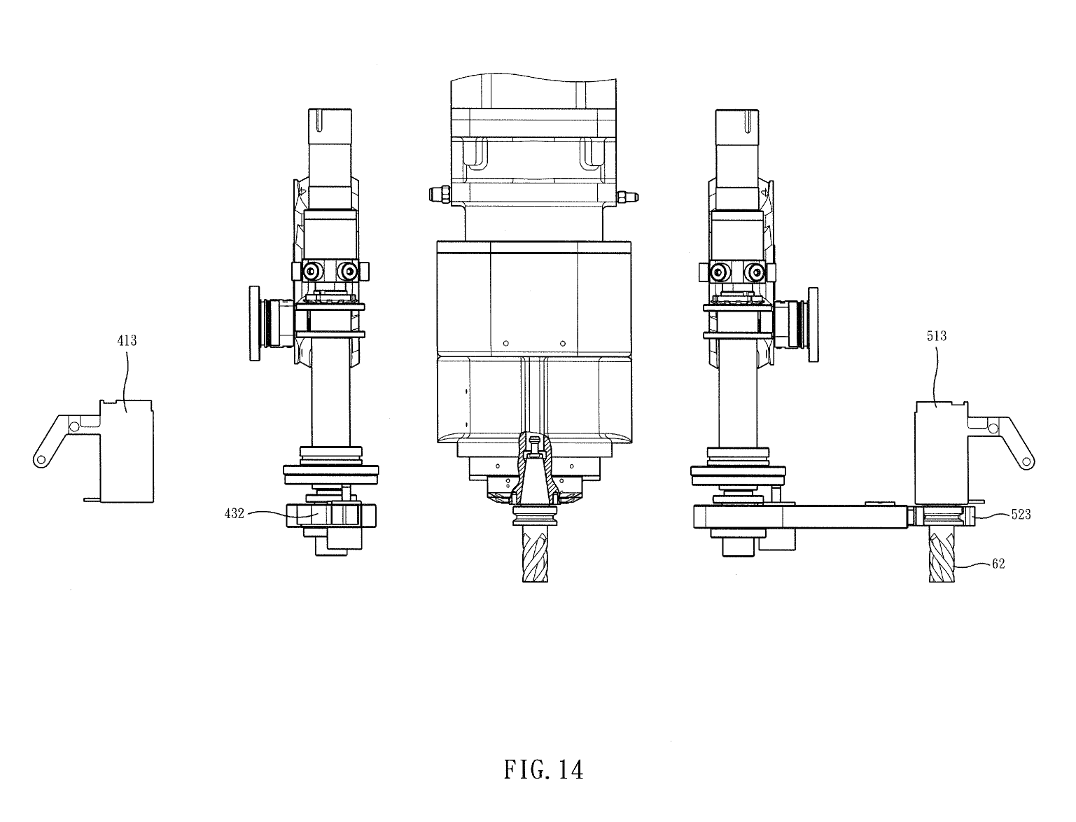

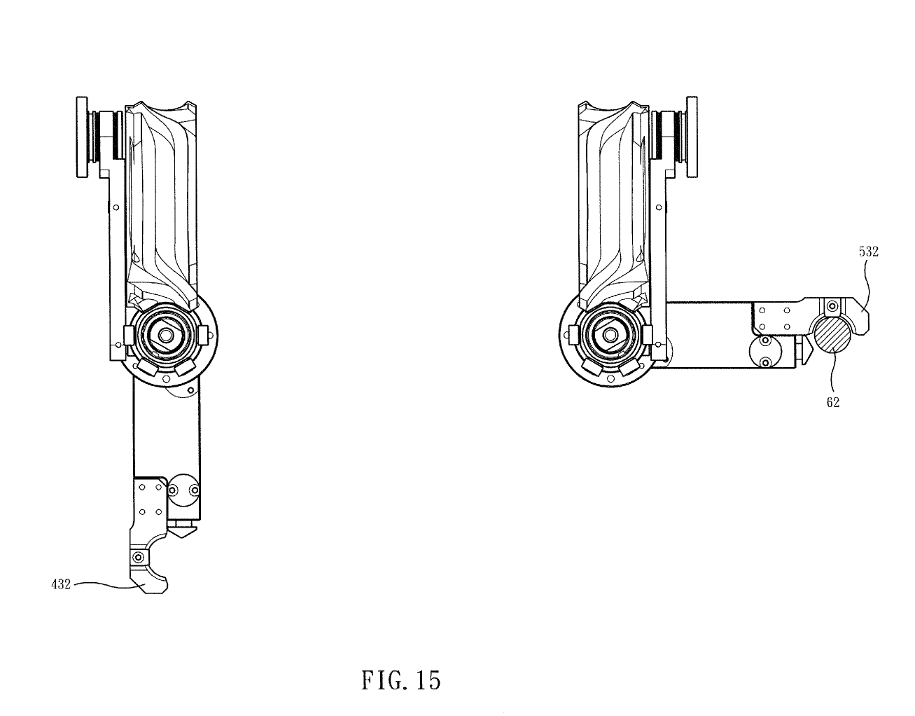

Referring to FIGS. 14 and 15, the first tool gripper 432 starts from the home position. When the first tool gripper 432 is located at the home position, the second tool gripper 532 is located at the magazine position and corresponds to the tool exit port 513 of the second tool magazine 51 to grip a new tool 62 extending out of the tool exit port 513.

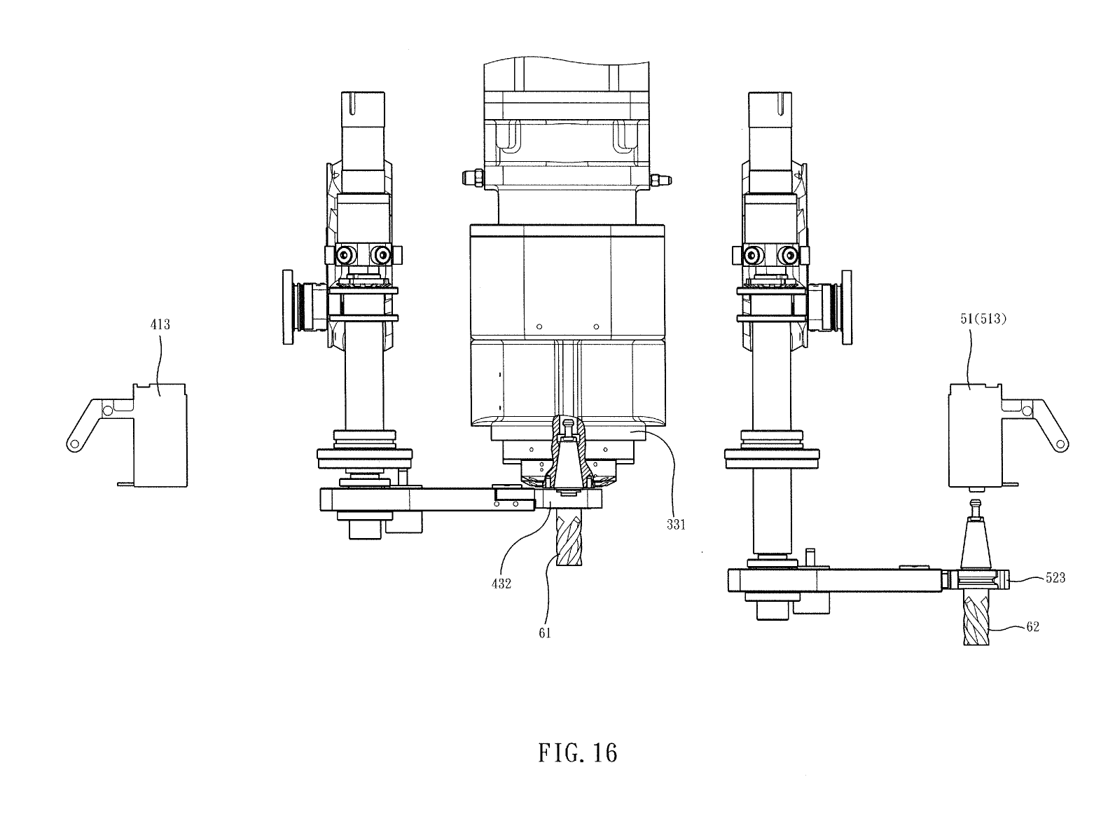

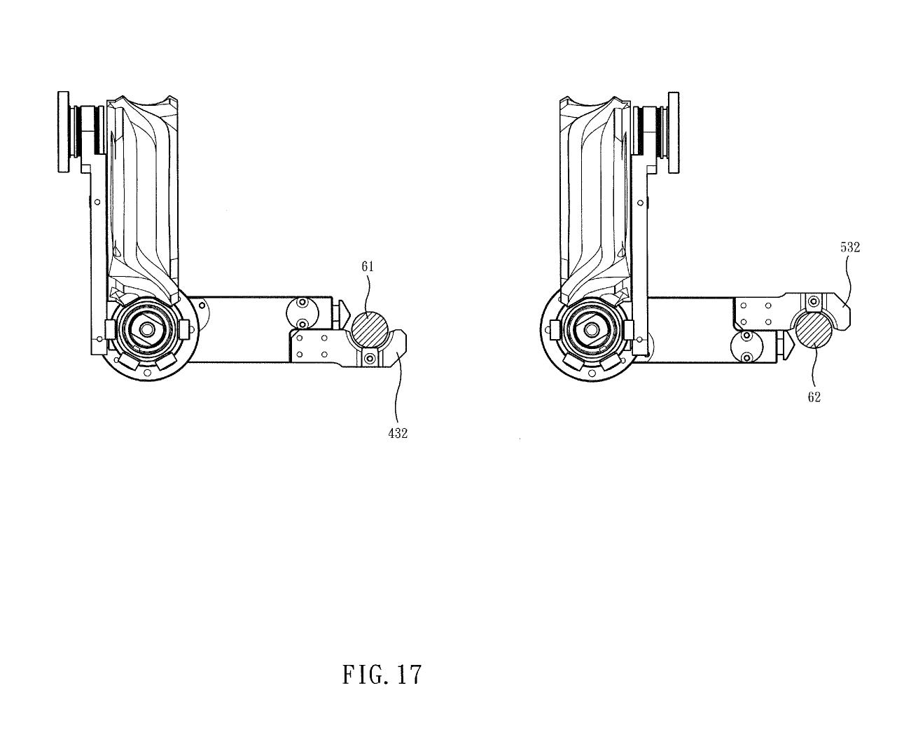

Referring to FIGS. 16 and 17, the first tool gripper 432 rotates 90 degrees and reaches the spindle position to correspond to the spindle 331 and grip a tool-to-be-changed 61 attached to the spindle 331. At the same time, the second tool gripper 532 moves downward to pick up the new tool 62 from the second tool magazine 51.

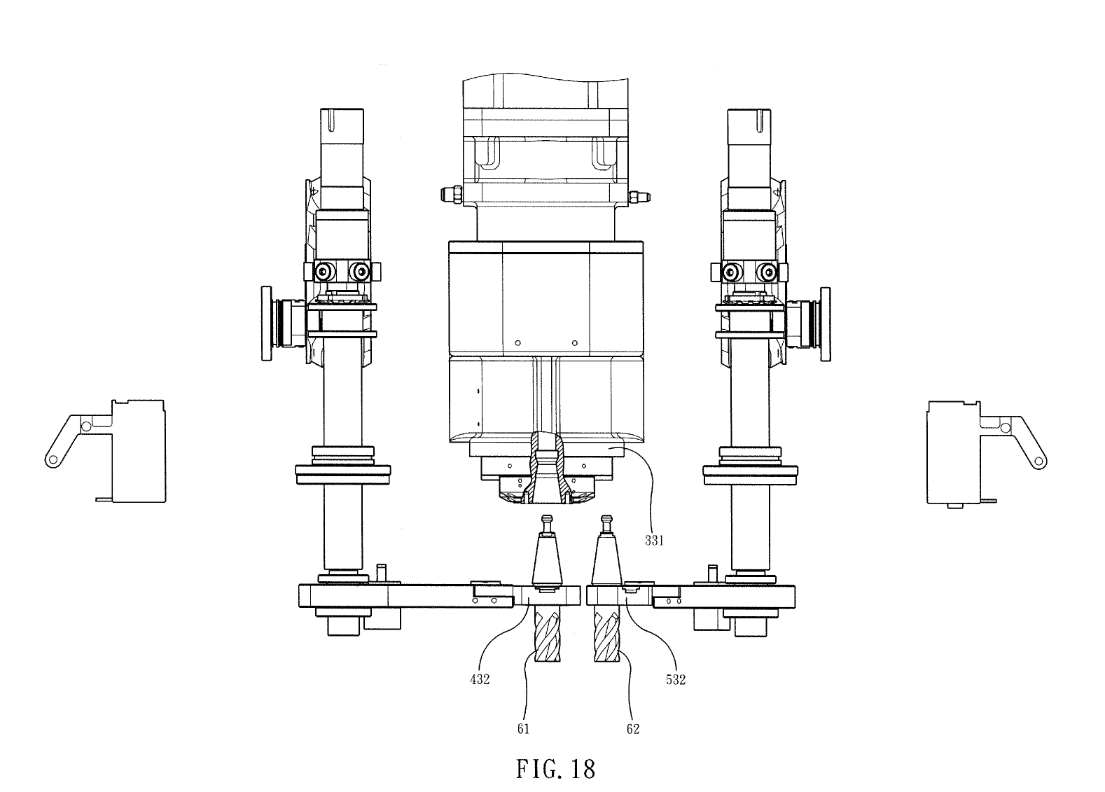

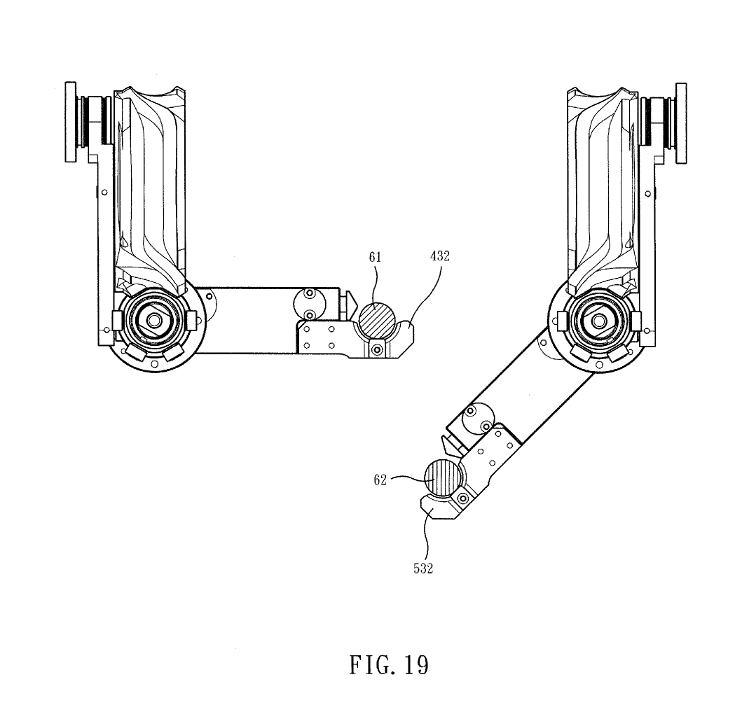

Referring to FIGS. 18 and 19, the first tool gripper 432 that is located at the spindle position moves downward to remove the tool-to-be-changed 61 from the spindle 331. At the same time, the second tool gripper 532 rotates from the magazine position to a location adjacent to the spindle position to get ready for changing the tool and under this condition, the rotation angle for the second tool gripper 532 to reach the spindle position is less than 90 degrees.

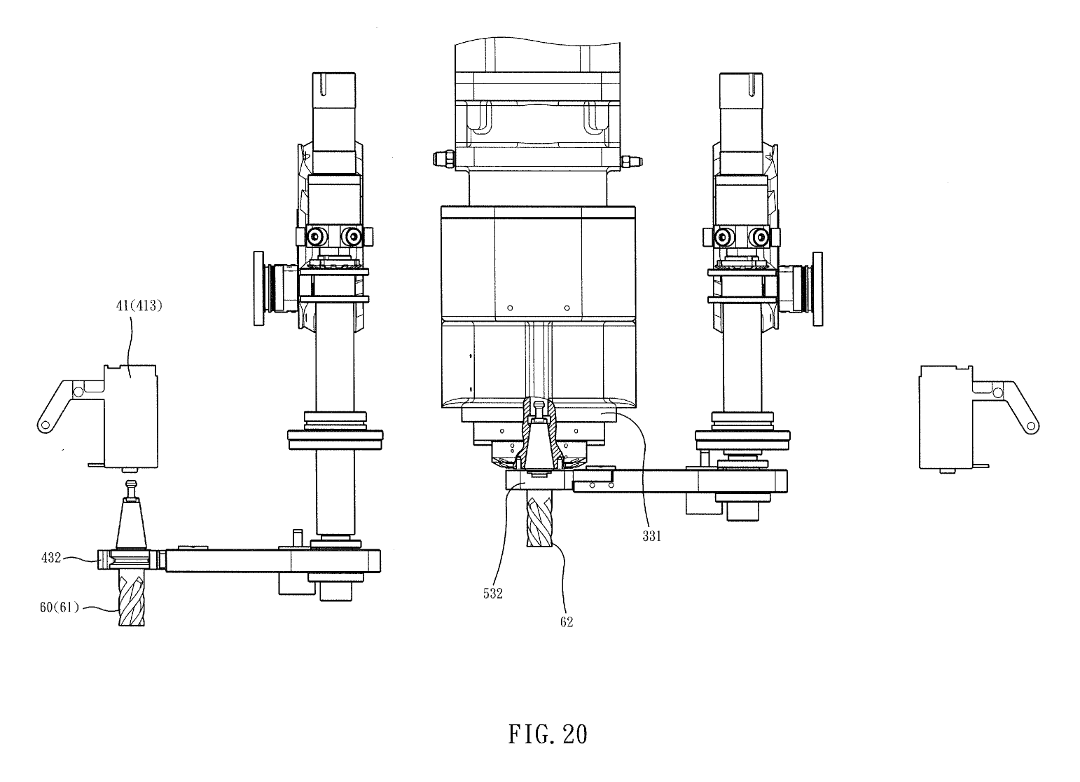

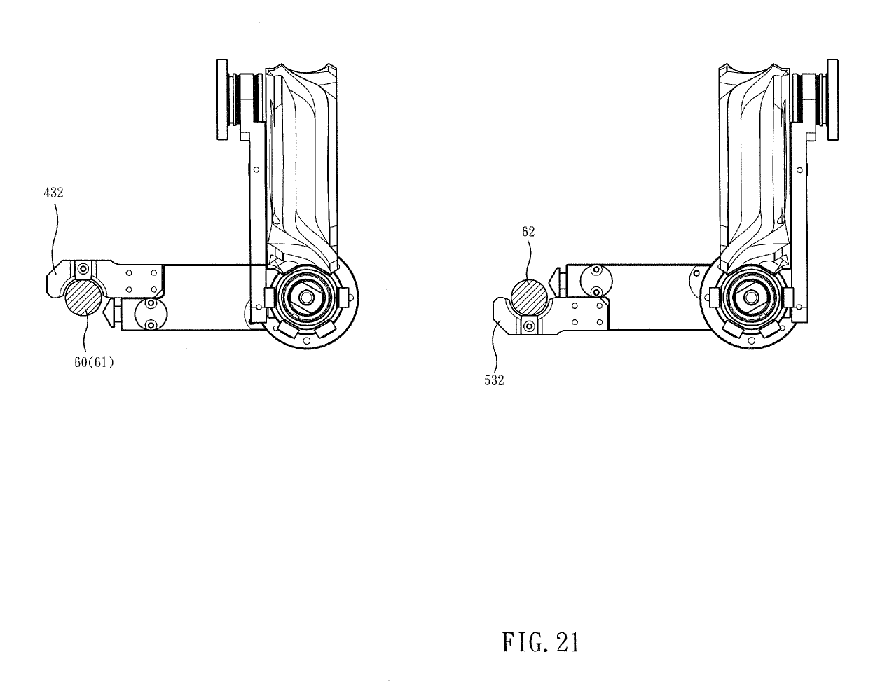

Referring to FIGS. 20 and 21, the first tool gripper 432 leaves from the spindle position and moves toward the magazine position. Due to the rotation angle thereof away from the spindle position being relatively small, the second tool gripper 532 can immediately occupy the spindle position that just got vacant when the first tool gripper 432 left and moves upward to attach the new tool 62 to the spindle 331.

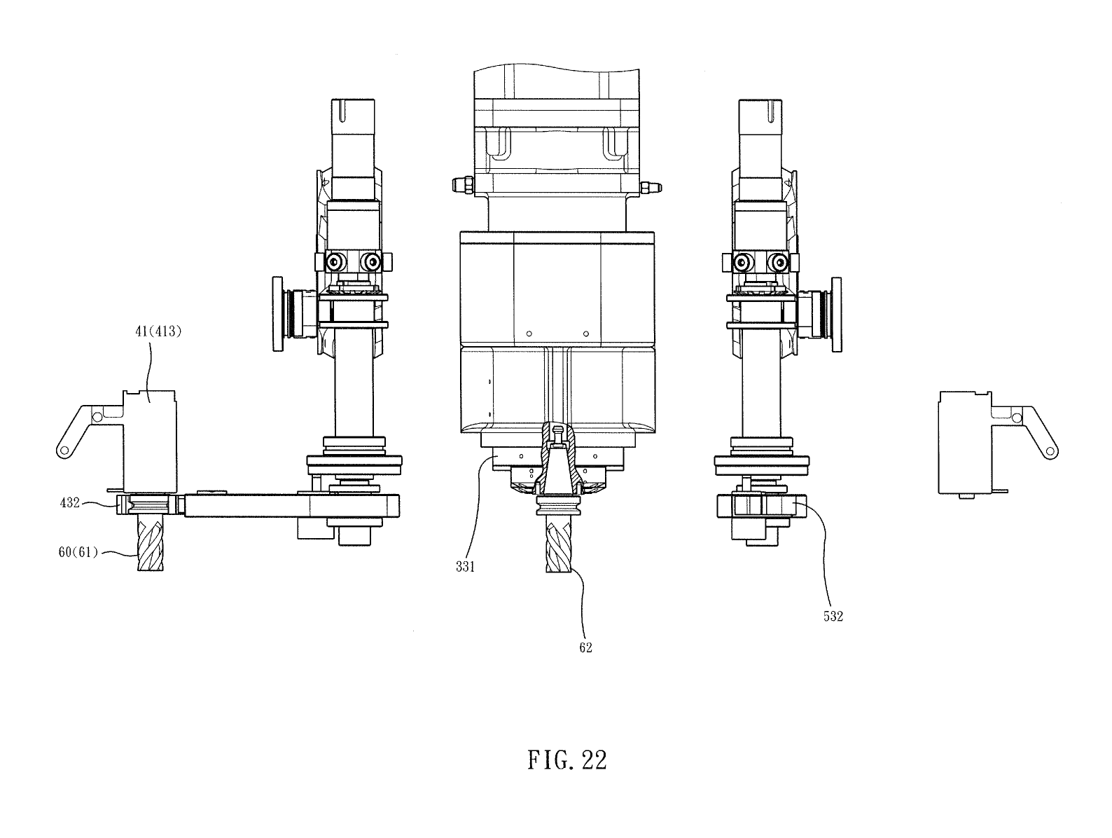

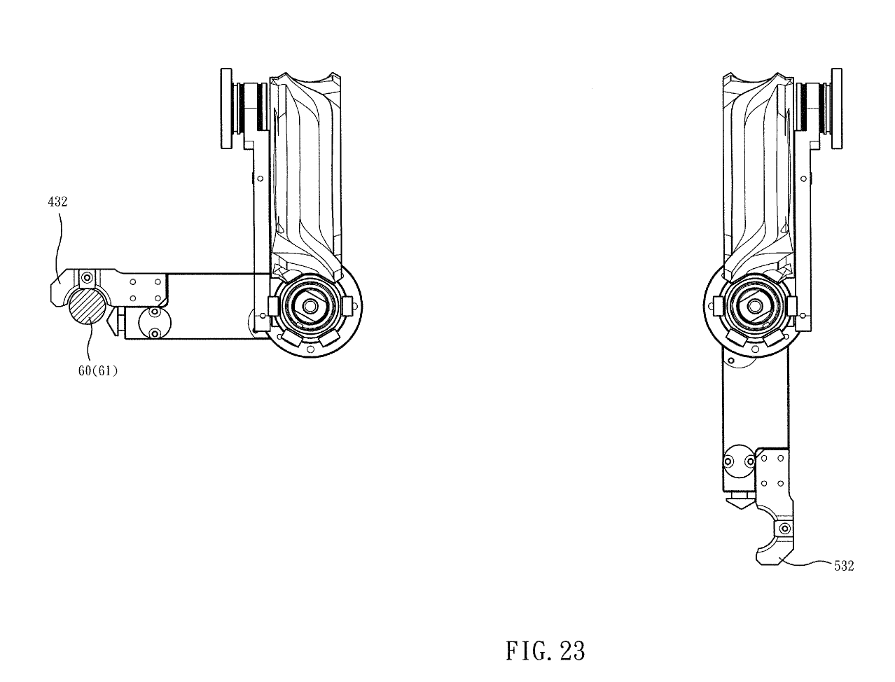

Referring to FIGS. 13, 22, and 23, the first tool gripper 432 reaches the magazine position and moves upward to place the tool-to-be-changed 61 that is removed from the spindle 331 through the tool exit port 413 back into the first tool magazine 41 and then picks up a tool 60 necessary for the next machining operation. The second tool gripper 532, after having the new tool 62 attached, leaves the spindle position and rotates 90 degrees to reach the home position. Under this condition, the first and second tool grippers 432, 532 are both away from the spindle position, so that the spindle 331 is allowed to descend to proceed with machining of the work piece retained on the work table 32 with the new tool 62. To this point, the ending positioning of the first and second tool grippers 432, 532 are exactly opposite to the starting points shown in FIGS. 16 and 17. It can be readily appreciated that in the next cycle, the operations of the first and second tool grippers 432, 532 will be switched and go through the processes illustrated from FIGS. 16 and 17 to FIGS. 22 and 23 and repeatedly cyclically to allow the first and second tool grippers 432, 532 to work in combination with each other to complete all the necessary processes of tool changes for the spindle 331.

In summary, the present invention has an advantages of possessing two sets of tool magazines of a conventional CNC machine center and can realize storage and management of a great number of diversified tools. Further, when one of the first and second tool grippers 432, 532 is set at the spindle position for removing the tool-to-be-changed 61 from the spindle 331, the other one is holding a new tool 62 at a location between the magazine position and the spindle position, preferably at a position between the home position and the spindle position so that a rotation angle to reach the spindle position is made extremely small. Thus, when the former leaves the spindle position, the later may take the position immediately without any undesired rotation of 180 degrees of the tool change arms as that required by the conventional CNC machine center that completes the tool change process with a waste of around half of the time of a cycle. Thus, the present invention can effectively reduce the time required for each tool change operation and greatly increases the speed of tool change, so that the present invention can meet the need for machining of work pieces of highly complicated shapes and is suitable for long-term machining operations.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tool change device, adopted to be use in a CNC (Computer Numerical Control) machine center, wherein the CNC machine center comprises a chassis unit and a machining unit that is mounted to the chassis unit and is reciprocally movable along a center axis, the machining unit comprising a spindle that is mounted along the center axis to receive a tool to be removably attached thereto, the tool change device of the CNC machine center comprising:
a first tool change unit, which is arranged at a side of the center axis and comprises a first tool magazine that receives and holds therein a plurality of tools and has a tool exit port and a first tool change arm arranged between the spindle and the first tool magazine, the first tool change arm comprising a first fixed end and a first tool gripper that is distant from the first fixed end and selectively and releasable grips a tool; and
a second tool change unit, which is arranged at an opposite side of the center axis and comprises a second tool magazine that receives and holds a plurality of tools and has a tool exit port and a second tool change arm arranged between the spindle and the second tool magazine, the second tool change arm comprising a second fixed end and a second tool gripper that is distant from the second fixed end and selectively and releasably grips a tool;
wherein the first and second tool grippers are operable to rotate about the first and second fixed ends with respect to the chassis unit so as to each circulate between the spindle and the respective tool exit port to have a tool attached to the spindle and one of the tools of the first and second tool magazines exchange with each other in such a way that the first and second tool grippers do not contact each other during the rotation thereof.

2. The tool change device according to claim 1, wherein the first tool gripper is rotatable about a first axis that extends through the first fixed end and is parallel to the center axis and the second tool gripper is rotatable about a second axis that extends through the second fixed end and is parallel to the center axis.

3. The tool change device according to claim 2, wherein the first and second tool grippers are respectively reciprocally movable along the first and second axes with respect to the chassis unit.

4. The tool change device according claim 1, wherein the first and second tool grippers are each operable to circulatively rotate with respect to the chassis unit among a home position, a spindle position, and a magazine position, where the first and second tool grippers correspond to the spindle when at the spindle positions so that the first and second tool grippers are operable to remove the tool from the spindle or to attach a new tool to the spindle; the first and second tool grippers respectively correspond to the tool exit ports thereof when at the magazine positions so as to each selectively place the tool removed from the spindle into the tool exit port or to pick up a new tool from the tool exit port; and when one of the first and second tool grippers is located at the spindle position to remove the tool from the spindle, the other one holds a new tool and is located at a position between the magazine position and the spindle position.

5. The tool change device according claim 2, wherein the first and second tool grippers are each operable to circulatively rotate with respect to the chassis unit among a home position, a spindle position, and a magazine position, where the first and second tool grippers correspond to the spindle when at the spindle positions so that the first and second tool grippers are operable to remove the tool from the spindle or to attach a new tool to the spindle; the first and second tool grippers respectively correspond to the tool exit ports thereof when at the magazine positions so as to each selectively place the tool removed from the spindle into the tool exit port or to pick up a new tool from the tool exit port; and when one of the first and second tool grippers is located at the spindle position to remove the tool from the spindle, the other one holds a new tool and is located at a position between the magazine position and the spindle position.

6. The tool change device according claim 3, wherein the first and second tool grippers are each operable to circulatively rotate with respect to the chassis unit among a home position, a spindle position, and a magazine position, where the first and second tool grippers correspond to the spindle when at the spindle positions so that the first and second tool grippers are operable to remove the tool from the spindle or to attach a new tool to the spindle; the first and second tool grippers respectively correspond to the tool exit ports thereof when at the magazine positions so as to each selectively place the tool removed from the spindle into the tool exit port or to pick up a new tool from the tool exit port; and when one of the first and second tool grippers is located at the spindle position to remove the tool from the spindle, the other one holds a new tool and is located at a position between the magazine position and the spindle position.

7. The tool change device according to claim 4, wherein when one of the first and second tool grippers is located at the spindle position to remove the tool from the spindle, the other one holds a new tool and is located at a position between the home position and the spindle position.

8. The tool change device according to claim 5, wherein when one of the first and second tool grippers is located at the spindle position to remove the tool from the spindle, the other one holds a new tool and is located at a position between the home position and the spindle position.

9. The tool change device according to claim 6, wherein when one of the first and second tool grippers is located at the spindle position to remove the tool from the spindle, the other one holds a new tool and is located at a position between the home position and the spindle position.
